(19) United States
(12) Patent Application Publication
(10) Pub. No.: US 2026/0210394 A1
(43) Pub. Date: Jul. 23, 2026

(54) FASTENER

(71) Applicant: DIN-HWA WU, KAOHSIUNG CITY (TW)

(72) Inventor: DIN-HWA WU, KAOHSIUNG CITY (TW)

(21) Appl. No.: 19/405,723

(22) Filed: Dec. 2, 2025

(30) Foreign Application Priority Data
Jan. 22, 2025 (TW) 114102822

(51) Int. Cl. F16B 25/00; F16B 25/10; F16B 33/02

(52) U.S. Cl. CPC F16B 25/0078; F16B 25/10; F16B 33/02

(57) ABSTRACT

A fastener includes a head, a shank, a drilling portion connected to the shank, a threaded portion spirally disposed on the shank, and an auxiliary portion disposed on the shank and between thread convolutions of the threaded portion. The auxiliary portion has a plurality of cone units and channels. Each channel is formed between any two adjacent cone units. The cone units assist the threaded portion in severing fibers of a workpiece, thereby achieving a multi-stage cutting effect. The channels help attain a quick removal of severed fibers and accommodate an adequate number of remaining severed fibers. Further, the cone units help attain a multi-point engagement effect to achieve a tight engagement between the fastener and the workpiece, thereby improving a positioning effect.

### BACKGROUND OF THE INVENTION

### 1. Field of the Invention

This invention relates to a fastener and relates particularly to a fastener capable of improving a tightening effect and preventing loosening.

### 2. Description of the Related Art

Referring to FIG. 1, a conventional fastener 1 comprising a shank 11, a head 12 disposed at one end of the shank 11, a drilling portion 13 disposed at another end of the shank 11 and opposite to the head 12, and a threaded portion 14 spirally disposed on a peripheral surface 11a of the shank 11. The threaded portion 14 has a plurality of thread convolutions 141 and a passage 142 formed between the thread convolutions 141. The drilling portion 13 is tapered from the shank 11 to form a drilling point 131. Referring to FIG. 2, after the drilling point 131 of the drilling portion 13 is positioned on a surface of a workpiece 2, the head 12 receives a rotational force caused by a tool (not shown) in order that the drilling portion 13 is pushed downwards and gradually drilled into the workpiece 2. The thread convolutions 141 then follow the drilling portion 13 to cut the workpiece 2 when the thread convolutions 141 are in contact with the workpiece 2 so that the shank 11 is inserted into the workpiece 2 with the aid of the thread convolutions 141. Fibers of the workpiece 2 are cut into cut chips by the thread convolutions 141, and the cut chips are discharged outwards through the passage 142. Thus, a screwing operation of the fastener 1 is completed when the head 12 is set flush, thereby attaining a positioning effect.

However, the drilling portion 13 is pressed by the rotational force and pushed downwards to attain a reaming effect and allow the drilling portion 13 to be inserted into the workpiece 2, and that will result in an increase of the screwing resistance and reduce the screwing speed when the drilling portion 13 is forced to press the workpiece 2. Meanwhile, the workpiece 2 may crack caused by the improper pressing. In addition, when the drilling portion 13 is drilled into the workpiece 2 to form a circular hole, the periphery of the drilling portion 13 tightly fits with the periphery of the circular hole because the drilling portion 13 is formed to have a conical shape. Thus, cut chips caused by the drilling portion 13 are difficult to be discharged outwards because no extra space is provided between the drilling portion 13 and the circular hole. Further, during the screwing operation, only the thread convolutions 141 are adapted to cut the workpiece 2, and that is insufficient for severing the fibers of the workpiece 2 entirely. Therefore, the shank 11 may be entangled by the unsevered fibers, and that will also increase the screwing resistance and decelerate the screwing operation. The fibers entangled around the shank 11 will further hinder the cut chips from being discharged outwards and cause cracking in the workpiece 2, and that require to be improved.

### SUMMARY OF THE INVENTION

The object of this invention is to provide a fastener capable of increasing the cutting efficiency effectively, attaining a quick removal of cut chips, reducing the screwing resistance, and achieving a stable positioning effect.

The fastener of this invention comprises a head, a shank extended outwards from the head, a threaded portion spirally formed on the shank, a drilling portion opposite to the head and tapered to form a drilling point, and an auxiliary portion formed on the shank. The threaded portion has a plurality of thread convolutions spirally disposed on a peripheral surface of the shank. The auxiliary portion has a plurality of cone units disposed between the thread convolutions and a plurality of channels defined between the cone units. Each cone unit has a base portion connected to the peripheral surface of the shank and a conical portion connected to the base portion. The conical portion is extended from the base portion and tapered to form a tip. During a screwing operation of the fastener, the auxiliary portion assists the threaded portion in cutting fibers of a workpiece, thereby preventing the shank from being entangled by the unsevered fibers, crumbling the fibers into cut chips, and greatly reducing the screwing resistance. The channels assist in excluding the cut chips quickly, thereby preventing the workpiece from cracking caused by pressing the cut chips improperly. The channels also allow the proper accumulation of the cut chips while the cone units help attain a multi-point engagement effect, thereby greatly increasing the tightening force, achieving a tight engagement between the fastener and the workpiece, and facilitating the screwing operation to be stable, speedy, and labor-saving.

Preferably, each cone unit defines a baseline extended from a center point of the base portion and passing through the tip of the conical portion. The baseline is inclined to the peripheral surface of the shank.

Preferably, each cone unit defines a baseline extended from a center point of the base portion and passing through the tip of the conical portion. The baseline is perpendicular to the peripheral surface of the shank.

Preferably, the shank includes a first section situated away from the drilling portion and a second section located between the first section and the drilling portion. The auxiliary portion is disposed on the first section.

Preferably, the drilling portion has at least three drilling surfaces so that the drilling portion has a polygonal shape. A cutting edge is formed at a junction of any two adjacent drilling surfaces.

Preferably, a connecting section is disposed between the shank and the head. A plurality of ribs are disposed on the connecting section.

Preferably, the ribs are helically disposed on the connecting section.

### BRIEF DESCRIPTION OF THE DRAWINGS

FIG. 1 is a schematic view showing a conventional fastener;

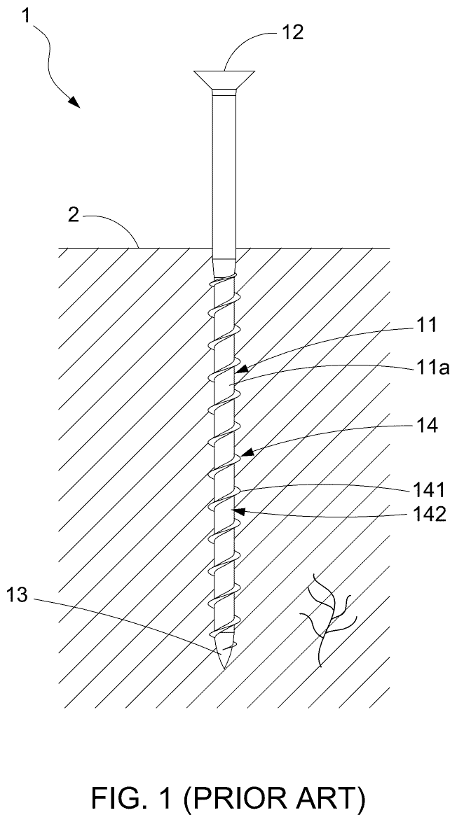

FIG. 2 is a cross-sectional view showing a screwing operation of the conventional fastener when the drilling portion is drilled into the workpiece;

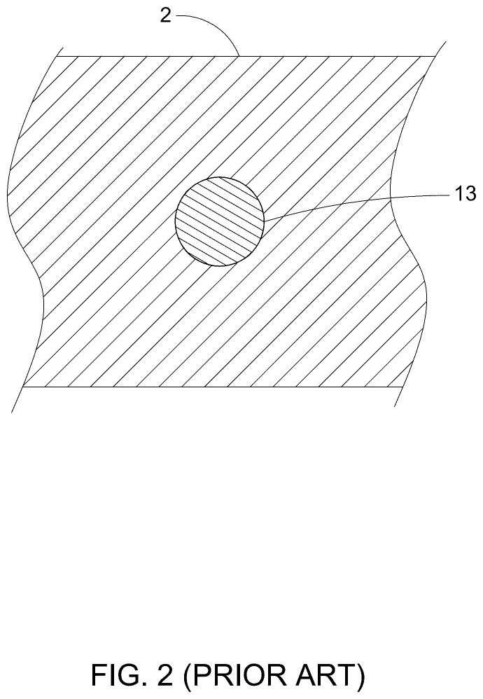

FIG. 3 is a perspective view showing a first preferred embodiment of this invention;

FIG. 4 is a cross-sectional view showing that the baseline defined by each cone unit is perpendicular to the peripheral surface of the shank;

FIG. 5 is a cross-sectional view showing that the baseline defined by each cone unit is inclined to the peripheral surface of the shank; and

FIG. 6 is a cross-sectional view showing a screwing operation of the first preferred embodiment of this invention when the drilling portion is drilled into the workpiece.

### DETAILED DESCRIPTION OF THE PREFERRED EMBODIMENTS

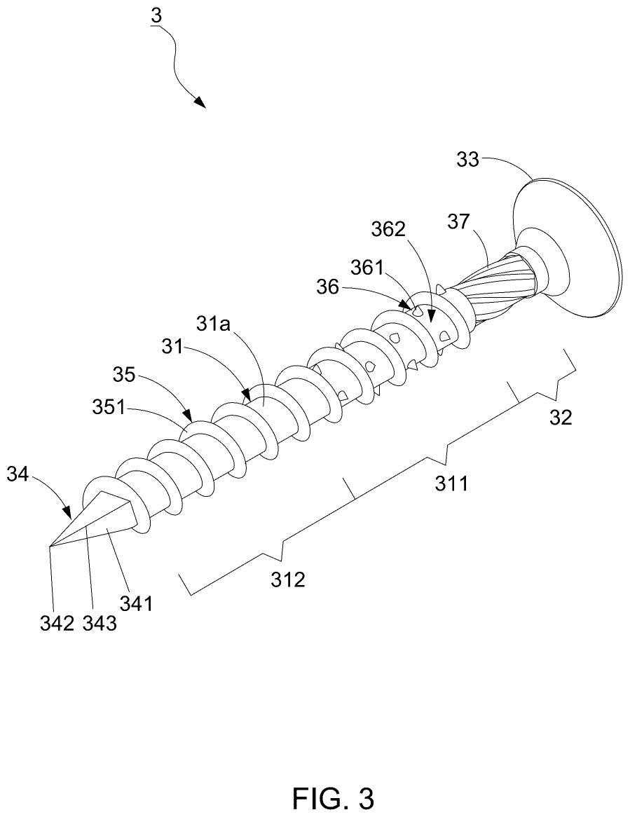

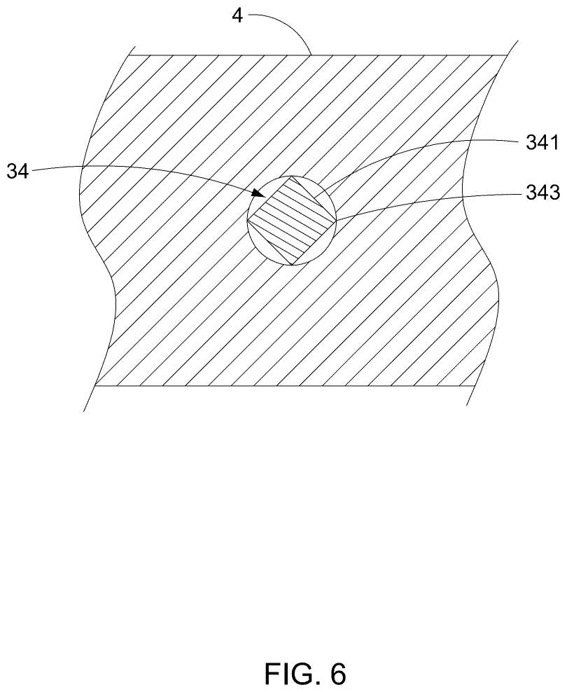

Referring to FIG. 3, a first preferred embodiment of a fastener 3 of this invention is disclosed. The fastener 3 includes a shank 31, a connecting section 32 disposed at one end of the shank 31, a head 33 connected to the connecting section 32, a drilling portion 34 disposed at another end of the shank 31 and opposite to the head 33, a threaded portion 35 spirally disposed on the shank 31, an auxiliary portion 36 spirally disposed on the shank 31 and crossing the threaded portion 35, and a plurality of ribs 37 helically disposed on the connecting section 32. The threaded portion 35 has a plurality of thread convolutions 351 spirally disposed on a peripheral surface 31a of the shank 31. The drilling portion 34 has at least three drilling surfaces 341 connected to the shank 31 and tapered to form a drilling point 342 so that the drilling portion 34 has a polygonal shape. A cutting edge 343 is formed at a junction of any two adjacent drilling surfaces 341. Referring to FIG. 3, here takes an example that the drilling portion 34 has four drilling surfaces 341. Each drilling surface 341 is flat in shape, namely in a non-curved form in cross section as shown in FIG. 6. Thus, the drilling portion 34 has a quadrilateral shape.

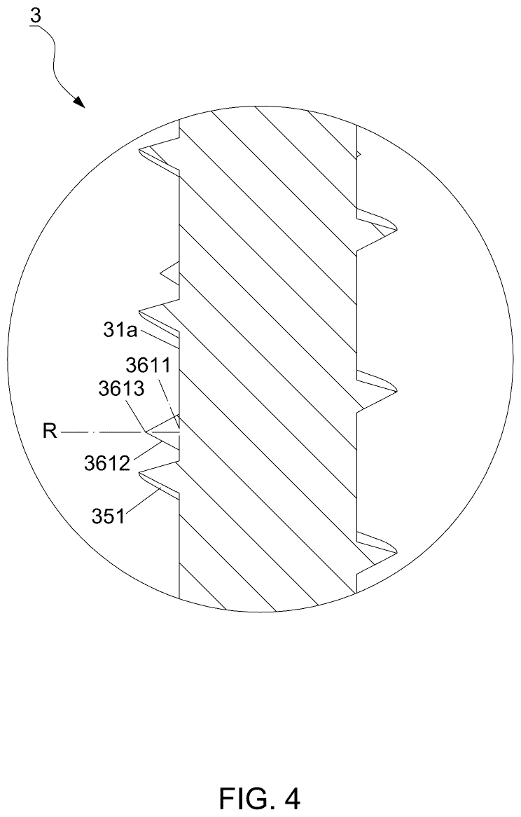

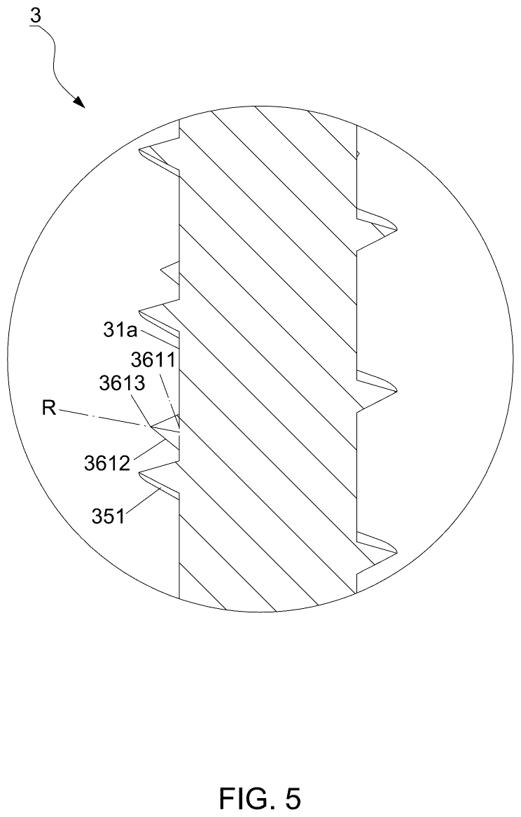

The shank 31 has a first section 311 connected to the connecting section 32 and a second section 312 connected to the drilling portion 34. In this preferred embodiment, the first section 311 and the second section 312 are connected at the center of the shank 31, namely the shank 31 is divided equally by the first section 311 and the second section 312. The auxiliary portion 36 is preferably disposed on the first section 311. The auxiliary portion 36 has a plurality of cone units 361 formed between the thread convolutions 351 and a plurality of channels 362 formed between the cone units 361. The cone units 361 are spaced from each other to thereby form each channel 362 between every two cone units 361. Each cone unit 361 has a base portion 3611 joined to the peripheral surface 31a of the shank 31 and a conical portion 3612 connected to the base portion 3611. The conical portion 3612 is extended outwards from the base portion 3611 and tapered to form a tip 3613. A baseline R is defined by extending from a center point of the base portion 3611 of one cone point 361 and passing through the tip 3613 of the same cone point 361. In this preferred embodiment, the baseline R is perpendicular to the peripheral surface 31a of the shank 31 as shown in FIG. 4. Another preferred embodiment is disclosed in FIG. 5 that the baseline R is inclined to the peripheral surface 31a of the shank 31.

Referring to FIGS. 3, 4 and 6, after the drilling point 342 of the drilling portion 34 is positioned against a surface of a workpiece 4, a rotational force is then applied to the head 33 in order to carry out a reaming operation of the drilling portion 34. Referring to FIG. 6, during the reaming operation, the cutting edges 343 formed at a junction of the drilling surfaces 341 assist in cutting the workpiece 4 so that the drilling portion 34 is drilled into the workpiece 4 smoothly to form a circular hole on the workpiece 4. The polygonal shape of the drilling portion 34 allows the drilling portion 34 to cut a periphery of the circular hole of the workpiece 4 quickly, thereby attaining a speedy reaming effect, achieving a multi-stage cutting effect, and accelerating the reaming operation. The flat drilling surfaces 341 help create extra space between the periphery of the drilling portion 34 and the periphery of the circular hole of the workpiece 4. Therefore, cut chips caused by breaking fibers of the workpiece 4 during the reaming operation are quickly removed outwards from the extra space, thereby preventing the cut chips from accumulating improperly, preventing an increase of the screwing resistance caused by the improper accumulated cut chips, and preventing the workpiece 4 from cracking caused by pressing the improper accumulated cut chips. Further, the polygonal shape of the drilling portion 34 helps attain a multi-point engagement effect, thereby achieving a tight engagement between the fastener 3 and the workpiece 4, increasing the tightening force, and improving a positioning effect.

The thread convolutions 351 then follow the drilling portion 34 to cut the workpiece 4 when the thread convolutions 351 are in contact with the workpiece 4. When the second section 312 of the shank 31 is screwed into the workpiece 4 with the aid of the thread convolutions 351, the screwing resistance will increase gradually because the fibers may not be completely severed by the thread convolutions 351 and the fibers will hinder the removal of the cut chips and entangle around the shank 31. The cone units 361 disposed on the first section 311 of the shank 31 then assist the thread convolutions 351 in cutting the workpiece 4, severing the fibers, and breaking the cut chips again, thereby reducing the screwing resistance, improving the cutting efficiency, increasing the cutting speed, preventing the shank 31 from being entangled by the unsevered fibers, and reducing the rotational force applied to drive the fastener 3. The ribs 37 also assist the auxiliary portion 36 in further breaking the fibers and crumbling the cut chips. Thus, the fastener 3 is screwed into the workpiece 4 quickly and smoothly. Meanwhile, the cut chips caused by cutting the fibers of the workpiece 4 are allowed to travel outwards through the channels 362 quickly, thereby preventing the improper accumulation of the cut chips, preventing an increase of the screwing resistance, and preventing the workpiece 4 from cracking caused by pressing the cut chips. The channels 362 also help accommodate an adequate number of the cut chips, thereby achieving a tight engagement between the fastener 3 and the workpiece 4 and improving a positioning effect. Further, when the fastener 3 is positioned in the workpiece 4, the cone units 361 assist in attaining a multi-point engagement effect to thereby achieve a tight engagement between the fastener 3 and the workpiece 4 and improve a positioning effect.

To sum up, the fastener of this invention takes advantages that the cone units are disposed on the shank and located between the thread convolutions to assist the thread convolutions in severing the fibers of the workpiece into the cut chips, thereby preventing the shank from being entangled by the fibers, reducing the screwing resistance, and improving the cutting efficiency. Each channel formed between any two adjacent cone units help attain a quick removal and a proper accumulation of the cut chips while the cone units help attain a multi-point engagement effect, thereby preventing the workpiece from cracking, accelerating the screwing operation, and achieving a tight engagement, and improving the positioning effect.

While the embodiments of this invention are shown and described, it is understood that further variations and modifications may be made without departing from the scope of this invention.

What is claimed is:

1. A fastener comprising:
a shank;
a head disposed at an end of said shank;
a drilling portion disposed at another end of said shank and tapered to form a drilling point;
a threaded portion spirally disposed on a peripheral surface of said shank and formed with a plurality of thread convolutions; and
an auxiliary portion disposed on said peripheral surface of said shank and located between said thread convolutions of said threaded portion, wherein said auxiliary portion includes a plurality of cone units formed between said plurality of thread convolutions, said auxiliary portion further including a plurality of channels, each of said plurality of channels being formed between any two adjacent cone units, each of said plurality of cone units having a base portion joined to said peripheral surface of said shank and a conical portion extended outwards from said base portion and tapered to form a tip.

2. The fastener according to claim 1, wherein each said cone unit defines a baseline extended from a center point of said base portion and passing through said tip of said conical portion, said baseline being inclined to said peripheral surface of said shank.

3. The fastener according to claim 1, wherein each said cone unit defines a baseline extended from a center point of said base portion and passing through said tip of said conical portion, said baseline being perpendicular to said peripheral surface of said shank.

4. The fastener according to claim 1, wherein said shank includes a first section situated away from said drilling portion and a second section located between said first section and said drilling portion, said auxiliary portion being disposed on said first section.

5. The fastener according to claim 1, wherein said drilling portion has at least three drilling surfaces so that said drilling portion has a polygonal shape, a cutting edge being formed at a junction of any two adjacent drilling surfaces.

6. The fastener according to claim 1, wherein a connecting section is disposed between said shank and said head, a plurality of ribs being disposed on said connecting section.

7. The fastener according to claim 6, wherein said plurality of ribs are helically disposed on said connecting section.
